(19) United States
(12) Patent Application Publication
(10) Pub. No.: US 2026/0075361 A1
(43) Pub. Date: Mar. 12, 2026

(54) AUDIO SYSTEM AND MOBILE DEVICE WITH ADAPTIVE COMPRESSOR

(71) Applicant: Sennheiser electronic SE & Co. KG, Wedemark (DE)

(72) Inventors: Steffen Matthias, Hannover (DE); Jan Watermann, Hannover (DE)

(73) Assignee: Sennheiser electronic SE & Co. KG, Wedemark (DE)

(21) Appl. No.: 19/319,852

(22) Filed: Sep. 5, 2025

(30) Foreign Application Priority Data
Sep. 12, 2024 (DE) 102024126210.9

(51) Int. Cl. H04R 3/12; H04R 29/00

(52) U.S. Cl. CPC H04R 3/12; H04R 29/001; H04R 2420/01; H04R 2420/07; H04R 2430/01; H04R 2499/11

(57) ABSTRACT

Embodiments disclosed herein relate to an audio system with a base station connected to multiple mobile devices. In some embodiments, the base station and the mobile devices are adapted to exchange data. In some embodiments, the base station is connected to an audio mixer adapted to receive multiple input signals from the mobile devices, mix them into an overall signal, provide them as an in-ear monitoring signal, and transmit them to a mobile device comprising an output amplifier and sound transducers connected thereto. In some embodiments, the mobile device, which receives the in-ear monitoring signal, may have a volume control to adjust playback volume. In some embodiments, the mobile device may have an audio compressor that compresses the input signal level of the in-ear monitoring signal as a function of the set volume so that the output level of the output amplifier does not exceed a predetermined limit level.

### FIELD

Embodiments disclosed herein relate to an audio system with an adaptive compressor and a mobile device with an audio compressor. Furthermore, embodiments disclosed herein relate to a method for transmitting device parameters set manually or automatically on a mobile device

### BACKGROUND

Background Audio systems for stages in which mobile microphones are used to transmit sound from instruments and singers to a base station are known. Usually, the audio signals are transmitted wirelessly via an RF channel that transmits analog or digital signals between the microphones and the base station. Wireless multichannel audio systems, for example, are known from the ETSI EN 300422 standard as Wireless Multichannel Audio Systems (WMAS). This type of audio system is a wireless audio system in which multiple channels are used for audio transmission. Multiple wireless transmitters (for example, wireless microphones) and multiple wireless receivers (for example, in-ear monitoring units) can communicate with a base station simultaneously.

In the aforesaid audio systems so-called belt packs are also used, which not only transmit an audio signal to the base station but also optionally receive an audio signal from the base station. The microphones and belt packs are collectively referred to as mobile devices, which in many cases are both transmitters and receivers.

A belt pack is typically connected to headphones to allow a user to hear an in-ear monitoring (IEM) signal during live performances, so that they can hear themselves and the musicians clearly. The IEM signal is provided at an audio mixer as an individual signal mix for each performer and transmitted to their belt pack. For this purpose, the audio mixer is connected to the base station. The user of the mobile device usually would like to hear the IEM signal as loudly as possible, which leads to distortion during playback, particularly during loud passages of the IEM signal, unless a complex amplifier is used, which has a high power consumption and reduces the battery life of a belt pack to an extent that is unacceptable for most applications. In conventional audio systems, this problem is addressed by clipping the signal level above a maximum output power of the headphone amplifier of the mobile device or by generally compressing the output level in the audio mixer connected to the base station. In the latter case, for example, the output signal of the audio mixer is compressed in such a way that the power limits of the headphone amplifier in the belt pack are not exceeded, even if the user of the belt pack has set the maximum volume for the in-ear monitoring signal. Both approaches lead to strong and undesirable distortions of the reproduced IEM signal.

The problem described occurs in all audio systems in which mobile devices reproduce an in-ear monitoring signal whose volume exceeds the output power of the headphone amplifier or the output amplifier of the belt pack.

In the priority application of this application, the German Patent and Trademark Office has searched the following documents: WO 2024/161 047 A2 and DE 10 2017 106 359 A1.

### SUMMARY

In some embodiments, an audio system may comprise a base station connected to a plurality of mobile devices. The base station and the plurality of mobile devices may be adapted to exchange data with each other. The base station may be connected to an audio mixer which may be adapted to receive a plurality of input signals from the plurality of mobile devices, mix them into an overall signal, provide them as an in-ear monitoring signal, and transmit them to a mobile device, which may comprise an output amplifier and sound transducers connected thereto. In some embodiments, the mobile device receiving the in-ear monitoring signal may have a volume control that allows a playback volume of the in-ear monitoring signal to be adjusted. In some embodiments, the mobile device may have an audio compressor that compresses an input signal level of the in-ear monitoring signal as a function of a set volume so that an output level of the output amplifier does not exceed a specified limit level.

In some embodiments, an audio system may comprise a base station connected to a plurality of mobile devices. The base station and the plurality of mobile devices may be adapted to exchange data with each other. The base station may be connected to an audio mixer which may be adapted to receive a plurality of input signals from the plurality of mobile devices, mix them into an overall signal, provide them as an in-ear monitoring signal, and transmit them to a mobile device, which may comprise an output amplifier and sound transducers connected thereto. In some embodiments, the mobile device receiving the in-ear monitoring signal may have a volume control that allows a playback volume of the in-ear monitoring signal to be adjusted. In some embodiments, a data value representing a set volume may be transmitted to the base station.

In some embodiments, a mobile device for an audio system may be adapted to output an in-ear monitoring signal and may have a volume control for adjusting a set volume of the in-ear monitoring signal. In some embodiments, the mobile device may have an audio compressor which compresses an input signal level of the in-ear monitoring signal as a function of the set volume such that an output level of an output amplifier does not exceed a predetermined limit level.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 shows a schematic diagram of a wireless multi-channel audio system according to some embodiments;

FIG. 2 shows a schematic representation of time slots of various wireless transmitters according to some embodiments;

FIG. 3 shows the time course of the level of output signals according to some embodiments;

FIG. 4A-4D show schematic characteristic diagrams of the output level as a function of the input level according to some embodiments;

FIG. 5A, 5B show schematic diagrams of characteristics of a headphone amplifier according to some embodiments; and

FIG. 6 shows a schematic flow diagram for a method for transmitting a device setting of a mobile device according to some embodiments.

In the following, the terms “output level,” “level of the output signal,” and “volume of the output signal” are used synonymously.

### DETAILED DESCRIPTION

According to a first aspect, an audio system is proposed comprising a base station connected to a plurality of mobile devices. The base station and the mobile devices are adapted to exchange data with each other. The base station is connected to an audio mixer adapted to receive a plurality of input signals from the mobile devices, mix them into an overall signal, and provide it as an in-ear monitoring signal and transmit it to a mobile device comprising an output amplifier and sound transducers connected thereto. The mobile device, which receives the in-ear monitoring signal, has a volume control that enables the playback volume of the in-ear monitoring signal to be adjusted. The mobile device also has an audio compressor that compresses the input signal level of the in-ear monitoring signal as a function of the set volume so that the output level of the output amplifier does not exceed a predefined limit level which corresponds to the maximum output level of the output amplifier and represents a physical limit determined by the available supply current for the output amplifier and the output amplifier component itself. The receipt of the IEM signal provided by the base station is the input of a digital processing chain on the mobile device. By means of digital signal processing, the digital signal is not compressed, compressed slightly, or severely compressed, depending on the headphone volume set by the user. The signal is then converted into the analog input signal of the output amplifier via a digital-to-analog converter.

According to a second aspect, a mobile device for an audio system is proposed. The mobile device is adapted to output an in-ear monitoring signal and has a volume control for adjusting the volume of the in-ear monitoring signal. The mobile device also has an audio compressor that compresses the input signal level of the in-ear monitoring signal as a function of the set volume such that the output level of the output amplifier does not exceed a predetermined limit level.

The audio system or the mobile device for such an audio system allows an audio compressor to be selectively and dynamically adjusted to a volume set on a mobile device, for example, for an IEM signal. This has the advantage that a headphone amplifier on a mobile device does not have to be designed for the loudest signals, which reduces the power consumption of the headphone amplifier and consequently has a favorable influence on the battery life of the mobile device. At the same time, clipping of the output signal level is avoided and thus the lowest possible distortion of the output signal is achieved. Instead, the passages of the output signal are compressed depending on the set volume so that the output level remains within a range that the output amplifier can amplify without distortion. In this way, a reproduction of the output signal which is as undistorted as possible can be achieved without the headphone amplifier of the mobile device having to be dimensioned so that it can reproduce the loudest passages of the in-ear monitoring signal. The latter has a positive effect on the dimensioning of a battery for the mobile device, i.e. a smaller battery than conventional mobile devices is sufficient to achieve the same running time as mobile devices that have a more powerful headphone amplifier. Likewise, embodiments disclosed herein can avoid the signal being permanently processed with an audio compressor that always processes the signal and in some cases for no reason. Instead, processing (i.e. a dynamic compression) may only be applied gradually the higher the desired volume is. If the user is listening quietly, the signal can be “passed through” unprocessed. If the user turns the volume up, the dynamics of the output signal are gradually compressed more and more strongly.

In one embodiment, a threshold value of the audio compressor can be set manually or automatically, above which the amplification of the output level is reduced.

In this embodiment, the threshold value above which the audio compressor reduces the dynamic range of the output signal can be manually adjusted by a user. Usually, this will be the user of the mobile device, who optionally adjusts the setting of the threshold value to the desired volume of the output signal. In some embodiments, it is further provided that the threshold value is automatically adjusted to the volume set by the user. In this case, it can also be provided that the automatically set threshold value can be manually overwritten by the user.

A compression factor of the audio compressor can be set manually or automatically, which determines by how much the output level specified by the volume control is reduced.

The compression factor, by which the audio compressor reduces the amplification of the output level, can be manually adjusted by a user according to some embodiments. Usually, this will be the user of the mobile device, who optionally adjusts the setting of the compression factor to the desired volume of the output signal. In some embodiments, it is also provided that the compression factor is automatically adjusted to the volume set by the user. In this case, it can also be provided that the automatically set compression factor can be manually overwritten by the user.

In one embodiment, the audio compressor is adapted so that its parametrization takes place automatically as a function of the manually set volume.

The automatic parameterization of the audio compressor relieves the user of additional setting tasks, which is a considerable relief for the user of the mobile device, especially during live performances.

In one embodiment, a data value representing the set volume can be transmitted to the base station.

Information as to which volume an artist has set for the IEM signal on their belt pack can be transmitted from the base station to the mixer of the sound engineer and provides the sound engineer with an insight into the wishes of the artist regarding the IEM signal. The sound engineer can respond by making changes to the IEM signal if necessary.

In this case, it can also be provided that the data value representing the set volume is also transmitted to another mobile device.

Transmitting the data value representing the volume to other mobile devices allows a musician to relieve their fellow musicians of the burden of adjusting the volume of the IEM signal. This is particularly advantageous when the volume of the IEM signal needs to be adjusted during a performance, but some musicians are already under considerable pressure due to the on-stage activity.

In one embodiment, it is provided that the other mobile device receives the same in-ear monitoring signal.

Transmitting the volume of the IEM signal from one mobile device to one or more other mobile devices is particularly advantageous when all the mobile devices receive the same IEM signal. Users listening to the IEM signal at low or moderate volumes hear the uncompressed IEM signal, whereas users listening to the IEM signal at high volumes hear a compressed IEM signal.

In one embodiment, it is possible by means of the data value representing the volume to provide an in-ear monitoring signal with an output level that corresponds to the output level of the in-ear monitoring signal on the mobile device.

In certain applications, for example, at classical music concerts, it can be desirable that the in-ear monitoring signal remains unchanged, i.e., is not compressed, regardless of the volume set on a mobile device. In this case, the compression factor can be set on the audio compressor and the input level of the in-ear monitoring signal in the mixer connected to the base station is adjusted so that the loudest passages remain within a range that the headphone amplifier of the mobile device can reproduce without distortion. In this case, a sound engineer can enter appropriate control commands at the mixer, which are then transmitted to the mobile device.

In one embodiment, the audio system is a multi-channel audio system with an antenna and a base station that provides an RF channel on which the base station and the mobile devices send and receive data in a multiplexing process.

The multi-channel audio system enables easy setup of an audio system with multiple mobile devices. If the multi-channel audio system is designed to be bidirectional, new possible applications that rely on bidirectional data exchange are then also opened up.

According to a third aspect, embodiments disclosed herein propose a method for transmitting a device setting to a mobile device in a multi-channel audio system. The mobile device communicates with a base station in the multi-channel audio system according to a multiplexing method. In some embodiments, the method comprises transmitting control data from the base station to the mobile device and transmitting device settings from the mobile device to the base station.

The method according to some embodiments has the advantage that transmission can take place manually or automatically on a mobile device in a multi-channel audio system from the mobile device to a base station. In particular, the method enables the transmission of a volume setting that the user of a mobile device has made on their mobile device. This information can be advantageous for a sound engineer, especially during live performances, to support the user with an in-ear monitoring signal adapted to their needs.

Embodiments herein are described without restricting the generality with reference to wireless multi-channel audio systems (“Wireless Multi-channel Audio System”, WMAS), which are known from the ETSI EN 300422 standard. In this case, several mobile devices, such as several microphones, several in-ear monitoring units can be used simultaneously with a base station. The problem that an in-ear monitoring signal is so loud that the performance limits of the headphone amplifier of a belt pack are exceeded also occurs with other audio systems. This disclosure is therefore not restricted to wireless multi-channel audio systems. For the sake of conciseness, however, the following description refers to wireless multi-channel audio systems.

If multiple audio transmitters (for example, a handheld microphone or other microphones) transmit audio signals to a base station simultaneously, and the base station transmits an audio signal composed of these audio signals to an in-ear monitoring unit or a belt pack, the microphones and the base station may not transmit simultaneously but subscriber access is accomplished using a Time Division Multiple Access (TDMA) method with a repeating frame with a number of time slots per RF channel. For example, 128 time slots per frame can be provided for the transmission of audio streams. Thus, up to 128 mobile devices can communicate with the base station. In addition, time slots can be provided for the transmission of control data, including the transmission of setting parameters of the mobile devices to the base station. For example, the volume of an in-ear monitor signal set by a user on a belt pack can be transmitted to the base station.

The TDMA method ensures multiple access to a wireless audio and data transmission through a time sequence of multiple subscribers. For the sake of conciseness, reference is made to audio data in the following. However, the system and method described herein is equally suitable for receiving other types of data and is by no means limited to audio data.

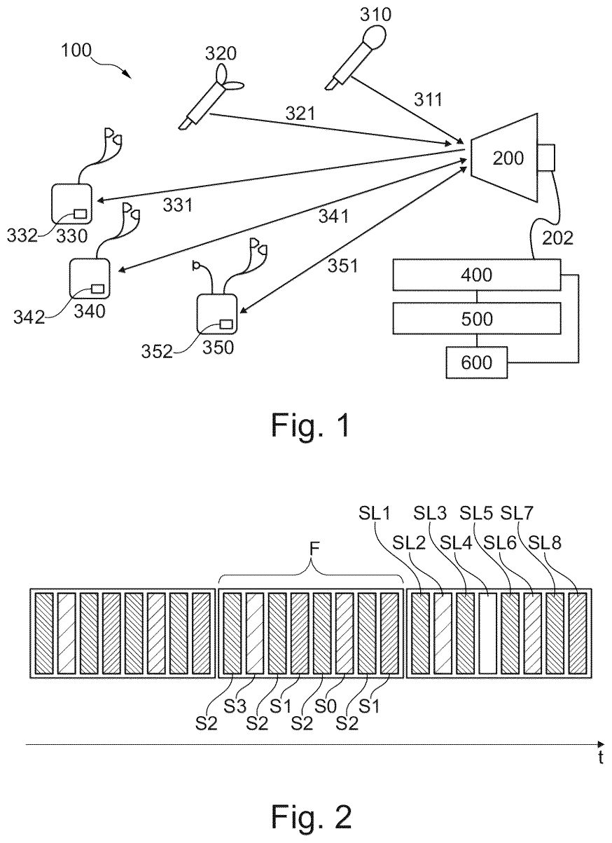

FIG. 1 shows a schematic representation of a wireless multi-channel audio system. The wireless multi-channel audio system (WMAS) 100 is based on the ETSI EN 300422 standard and comprises a base station 400, at least one antenna 200, and a plurality of mobile devices, e.g., at least one handheld microphone (mobile transmitter) 310, optionally at least one multi-channel microphone (mobile transmitter) 320, optionally a first belt pack (mobile receiver and transmitter) 330, 340 with an output for in-ear monitoring, optionally a combined second belt pack (mobile receiver and transmitter) 350 with an input for microphone signals and an output for in-ear monitoring. The number of mobile transmitters 310, 320 or mobile receivers 330, 340, 350 in the wireless multi-channel audio system 100 can vary.

In the wireless multi-channel audio system 100, the base station 400 is connected to an antenna 200 by means of a cable 202 and provides an RF channel. Optionally, additional antennae can be connected to the base station 400, which can provide additional RF channels. The antenna 200 can have an RF transmitter (“radiohead”), so that digital signals are transmitted via the cable 202, which are converted into analog RF signals in the radiohead.

The wireless multi-channel audio system 100 can have the channel bandwidth of 6 MHz, 8 MHz, or 10 MHz. Transmission takes place, for example, in the frequency ranges 470-698 MHz (UHF) and 1350-1525 MHz (1G4).

A control console 500 connected to the base station 400 can provide a user interface by means of which an operator can enter configuration and control commands for the base station 400. The control console 500 is, for example, a computer on which a software program for controlling the base station 400 is executed. The configuration and control commands, as well as the associated parameters, are stored in the base station 400 in a non-volatile memory as production data. In most practical applications, the base station 400 is signal-coupled to an audio mixer 600, although an audio mixer 600 is not necessarily provided but is rather an option. By means of the audio mixer 600, the audio signals from the respective wireless audio transmitters (e.g., microphones) can be mixed into an overall audio signal. The overall audio signal can be used as a transmission signal in radio productions, as an output signal for loudspeakers at concerts and, last but not least, as an input signal for in-ear monitoring devices (in-ear monitors for short), for example for the belt packs 330, 340, 350.

The signal transmission from microphones 310, 320 to the antenna 200 is represented in FIG. 1 by arrows 311 and 321, respectively. The transmission of in-ear monitoring signals from the antenna 200 to the belt packs 330, 340, 350 is illustrated by arrows 331, 341 and 351. At the same time, belt packs 330, 340 and 350 transmit setting and operating parameters to the antenna 200 or to the base station 400, respectively, which is why arrows 331, 341 and 351 are designed as double arrows. Furthermore, the mobile devices 330, 340 and 350 are each equipped with an audio compressor 332, 342 and 352, the function of which is explained further below.

FIG. 2 shows a representation of time slots of various wireless transmitters received by a wireless receiver. In the TDMA method, the respective audio transmitters are assigned a time slot in a frame. In FIG. 2, eight time slots SL1-SL8 are provided per frame SF by way of example. However, this is only an example for illustrative purposes. Thus, eight time slots SL1-SL8 can be transmitted per frame. The time slots SL1-SL8 are repeated in each frame F. In other exemplary embodiments, fewer or more than eight time slots can be provided.

In this example, three streams S1, S2, and S3 are present. Each stream is assigned a wireless audio transmitter. Furthermore, time slots 50 which are not used can be provided in the frame F. In the example in FIG. 2, the first stream S1 utilizes 2/8 of the resources, stream S2 utilizes 4/8, and stream S3 utilizes 1/8 of the resources. The first stream S1 occupies the time slots SL4 and SL8. The first, third, fifth, and seventh time slots SL1, SL3, SL5 and SL7 are occupied by the second stream S2. The third stream S3 occupies the time slot SL2. The sixth time slot SL6 is unused.

In the embodiment illustrated in FIG. 1, the microphones 310, 320 and the belt packs 330, 340 and 350 function as transmitters and receivers, just like the base station 400 since, as mentioned initially, not only audio data can be transmitted in the described time slots, but also setting and operating parameters of the mobile devices can be transmitted to the base station and conversely. For example, the battery charge level of mobile devices can be transmitted to the base station 400 in order to display this information for a sound engineer on a user interface of the control computer. Of particular interest in the following is that the volume setting on a belt pack for the in-ear monitoring signal can also be transmitted to the base station 400 and the control computer 500.

Professional musicians use in-ear monitoring to be able to hear themselves and their fellow musicians clearly during live performances. The in-ear monitoring signal can be transmitted from the audio mixer 600 via the base station 400 to the belt packs 330, 340 and 350. The audio mixer 600 is frequently located to the side of a stage and is operated by an engineer who can respond to the wishes of the artist. Each musician on stage usually has an individual signal mix, which is generated in the audio mixer 600. When creating the mixed signal (signal mix), the engineer usually leaves a certain level reserve, the so-called “headroom,” for the respective headphone amplifier of the relevant belt pack so that the signal is not digitally clipped during processing or leads to distortion with analog inputs.

A property of the in-ear monitoring signal for the musician is its volume, since in live situations, there is a lot of external background noise or ambient noise. The in-ear monitoring signal must be reproduced significantly louder than this ambient noise. The musician usually selects the output volume himself using a control on the receiver or the belt pack 330, 340 or 350, which he wears on his body.

The artist usually desires a very loud reproduction of his in-ear monitoring signal via his headphones. It should be noted that the headphone amplifier in a mobile in-ear receiver system is a significant power consumer and thus limits the battery life as a determining factor. Furthermore, the amplifier would have to be designed for very high peak currents to ensure distortion-free reproduction, even at very high volumes. This, in turn, further reduces battery life and has further disadvantages in terms of heat dissipation and dimensions, since larger batteries require more space and at the same time are also heavier, so that the wearing comfort for the artist is also restricted. For these reasons, it may be difficult to dimension the headphone amplifier in a belt pack for the in-ear monitoring signal in such a way that even isolated peak values of the output level are reproduced without distortion.

It is known to address this overload of the headphone amplifier by clipping or compressing the in-ear monitoring signal, wherein clipping is the cutting off of signal levels that exceed a predetermined threshold value. This approach is certainly simple but it results in distortion of the in-ear monitoring signal and is therefore not preferred. Compression of the in-ear monitoring signal is superior to clipping.

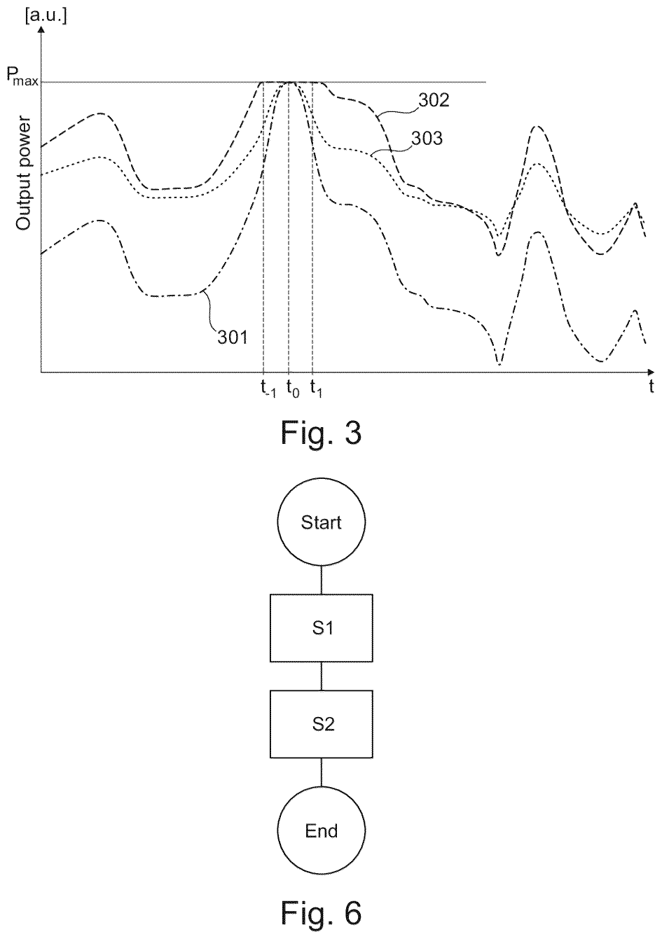

This relationship is illustrated in a schematic diagram in FIG. 3, which shows the time behavior of the output level of a headphone amplifier for three different cases. In the diagram shown in FIG. 3, time is plotted on the x-axis and the level of the output signal of the headphone amplifier is plotted in arbitrary units on the y-axis. At a volume setting of 0 dB, the input signal is output unamplified as output signal and is shown in FIG. 3 as a dashed line 301. At the time to, the output signal 301 reaches a level Pₘₐₓ, which corresponds to the maximum output power of the headphone amplifier. Before and after the time to, the output signal remains below the maximum level Pₘₐₓ. If the musician wants to hear the quiet passages of the IEM signal more loudly, he may turn up the volume control on his belt pack to obtain a louder signal. This louder signal is shown as a dashed line 302. This has the result that from the time t₋₁ to the time t₁, the level of the output signal is cut off (“clipped”), which leads to an undesirable distortion of the auditory impression. In order to avoid this undesirable effect, the output signal is compressed so that loud passages are amplified less than quiet passages. The compressed output signal is shown as dotted line 303. A comparison of the lines 302 and 303 reveals that the quiet passages of the compressed output signal 303 are reproduced almost as loudly as with the uncompressed output signal 302, but no clipping occurs. In particular, at the time t₀, the compressed output signal 303 has the same signal level as the unamplified output signal 301. Overall, the compression of the output signal has the effect that, on average, a louder output signal can be emitted without clipping of the output signal occurring, which distorts the auditory impression.

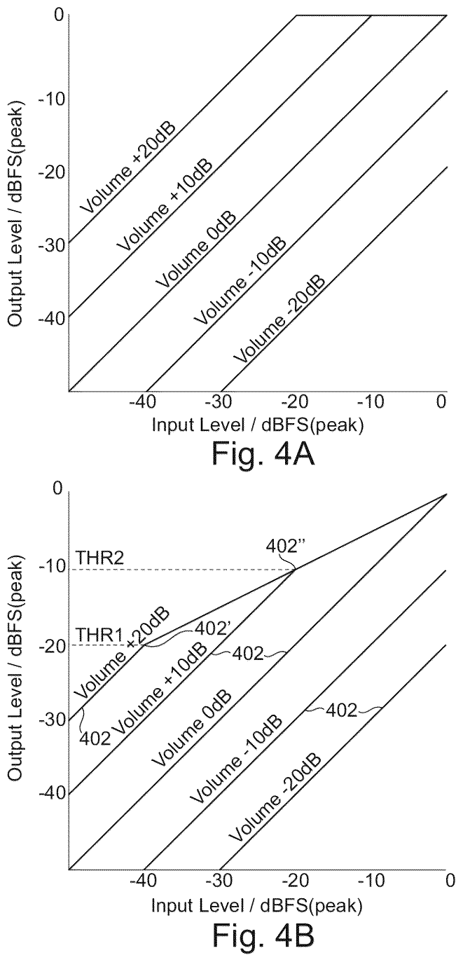

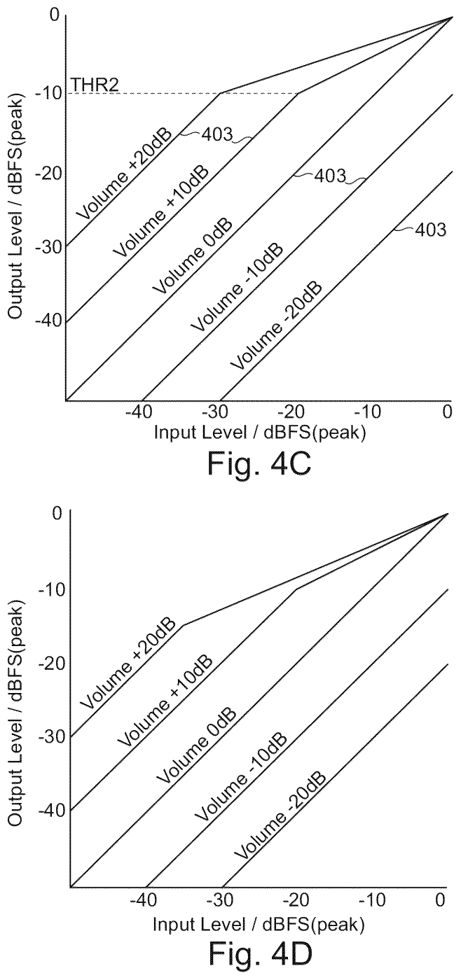

The effect of clipping and compression is graphically illustrated again in the diagrams in FIGS. 4A to 4D. In the diagrams, the level of an input signal, for example, the IEM signal, as output by the mixer 600 is plotted on the x-axis. The level of the output signal after amplification or attenuation according to the volume setting on the belt pack is plotted on the y-axis, where the input and output levels are represented in the unit dBFS (peak) (“Decibel Full Scale”), where 0 dBFS (peak) designates a maximum input or output value.

FIG. 4A shows a set of characteristic curves 401 that indicate the output level as a function of the input level at different volume settings, where 0 dB corresponds to a gain factor of 1, negative dB values correspond to a gain factor <1 and positive dB values correspond to a gain factor >1. As can be seen, the output levels reach the maximum level value 0 dBFS (peak) at a gain (volume setting) of +20 dB or +10 dB and are clipped to this value. The volume value appended to the reference symbol serves to distinguish between the different characteristic curves, i.e., 401_+20 dB, 401_+10 dB, etc.

FIG. 4B shows a set of characteristic curves 402. Without corrective measures, the characteristic curves 402_+20 dB and 402_+10 dB with a volume setting of +20 dB and +10 dB respectively would exceed the maximum output level of 0 dBFS (peak) at high input levels. In the example shown in FIG. 4B, however, the output signal is not clipped at 0 dBFS (peak) but the gain is reduced by a constant compression factor (“ratio”) depending on a time-varying signal power, which is applied to both the characteristic curve 402_+20 dB and the characteristic curve 402_+10 dB. The compression factor describes the ratio of uncompressed output level to compressed output level. That is to say that with a compression factor of 4:1, the uncompressed output level is four times higher than the compressed output level. The point at which the gain factor is reduced is visible as a kink 402′ or 402″ in the characteristic curve 402_+20 dB or 402_+10 dB. The reduction in the amplification begins at different threshold values (THR1 or THR2) for the two characteristic curves.

FIG. 4C shows a set of characteristic curves 403. Without corrective measures, the characteristic curves 403_+20 dB and 403_+10 dB with a volume setting of +20 dB and +10 dB respectively would exceed the maximum output level of 0 dBFS (peak) at high input levels. In the exemplary embodiment shown in FIG. 4C, the gain for the two characteristic curves 403_+20 dB and 403_+10 dB is reduced from the same threshold value THR2, with a larger compression factor being applied to the characteristic curve 403_+20 dB than to the characteristic curve 403_+10 dB, which can be seen from the smaller slope of the characteristic curve 403_+20 dB compared to the slope of the characteristic curve 403_+10 dB above the threshold value THR2.

FIG. 4D shows a set of characteristic curves 404, where, again without corrective measures, the characteristic curves 404_+20 dB and 404_+10 dB, with a volume setting of +20 dB and +10 dB, respectively, would exceed the maximum output level of 0 dBFS (peak) at high input levels. In this exemplary embodiment, both the threshold values and the compression factor are variable for different volume settings (here: +20 dB and +10 dB). Specifically, the characteristic curve 404_+20 dB is compressed with a first compression factor from the threshold value THR1, and the characteristic curve 404_+10 dB is compressed with a second compression factor from the threshold value THR2, where the first compression factor is greater than the second compression factor. This means that the slope of the characteristic curve 404_+20 dB above the threshold value THR1 is smaller than the slope of the characteristic curve 404_+10 dB above the threshold value THR2.

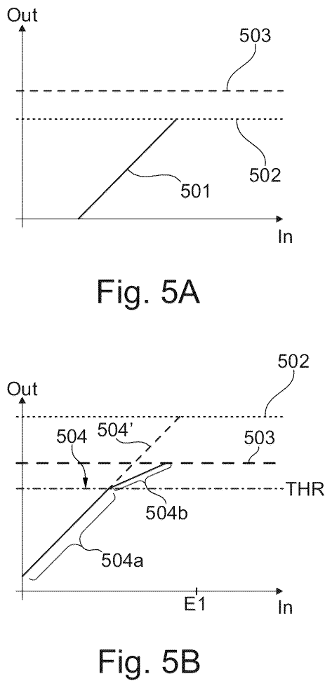

FIG. 5A shows a single characteristic curve 501 of an audio compressor (compressor for short). An input level is plotted on the abscissa and an output level of the compressor is plotted on the ordinate. The characteristic curve 501 shows a linear curve for the gain between the input and output levels with a constant gain factor V1. The gain factor V1 depends on the volume setting made by a user on their belt pack. A desired peak output level is shown as a dotted line 502. The maximum output level that can be amplified by the headphone amplifier without distortion is shown in FIG. 3A as a dashed line 503, which lies above the desired peak output level 502. In this configuration, the headphone amplifier thus has sufficient reserve to ensure linear amplification of the input signal.

If, however, the volume control on the belt pack is set so that peaks of the input signal result in the maximum output level of the headphone amplifier being exceeded, the compressor is activated, which, from a certain threshold value THR, reduces the peaks of the input signal level so that the maximum peak output level of the headphone amplifier remains below its maximum output level. This situation is illustrated in FIG. 5B. A characteristic curve 504 increases linearly in a first section 504a up to the threshold value THR with a first gain factor. Beyond the threshold value THR, the characteristic curve 504 continues as a dashed line 504′ up to the desired peak output level 502, which is reached at an input level E1. However, with the selected volume setting, the peak output level 502 would lie above the maximum output level 503 that the headphone amplifier can amplify without distortion. For this reason, the compressor implemented in the belt pack reduces the input level from the threshold value THR so that the maximum output level of the amplifier is not exceeded by the input level E1. This is shown in FIG. 3B by a bending section 504b in the characteristic curve 504. In the section 504b of the characteristic curve 504, the gain factor is V2, where V2<V1.

In an embodiment, the compressor can be implemented in the audio mixer 600, so that for the described setting, the volume level set on the belt pack can be transmitted to the audio mixer 600. This takes place in a time slot in a frame of the TDMA signal. In this way, it is advantageously achieved that the in-ear monitoring signal may only be compressed when an input level and the volume set for the respective belt pack, and thus the set gain factor, necessitate a compression of the output signal.

In yet another embodiment, the audio compressor can be implemented as a separate device that is communicatively connected to the control computer.

FIG. 6 shows a schematic flow diagram for a method for transmitting a device setting from a mobile device in a multi-channel audio system according some embodiments disclosed herein. The mobile device communicates with the base station 400 in the multi-channel audio system 100 according to a multiplexing method. In step S1, control data is transmitted from the base station 400 to the mobile device. In step S2, device settings of the mobile device are transmitted in the opposite direction to the base station.

Reference list

| | |
|---|---|
| 100 | Multi-channel audio system |
| 200 | Antenna |
| 301-303 | Characteristic curves |
| 310 | Mobile device |
| 311 | Arrow |
| 320 | Mobile device |
| 321 | Arrow |
| 322 | Audio compressor |
| 330 | Mobile device |
| 331 | Arrow |
| 332 | Audio compressor |
| 340 | Mobile device |
| 341 | Arrow |
| 342 | Audio compressor |
| 350 | Mobile device |
| 351 | Arrow |
| 352 | Audio compressor |
| 400 | Base station |
| 401-404 | Characteristic curves |
| 500 | Control console |
| 501-504 | Characteristic curves |
| 600 | Audio mixer |

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only

What is claimed is:

1. An audio system comprising a base station connected to a plurality of mobile devices, wherein the base station and the plurality of mobile devices are adapted to exchange data with each other, wherein the base station is connected to an audio mixer which is adapted to receive a plurality of input signals from the plurality of mobile devices, mix them into an overall signal, provide them as an in-ear monitoring signal, and transmit them to a mobile device, which comprises an output amplifier and sound transducers connected thereto,
wherein the mobile device receiving the in-ear monitoring signal has a volume control that allows a playback volume of the in-ear monitoring signal to be adjusted, and
wherein the mobile device has an audio compressor that compresses an input signal level of the in-ear monitoring signal as a function of a set volume so that an output level of the output amplifier does not exceed a specified limit level.

2. The audio system of claim 1, wherein a threshold value of the audio compressor is manually or automatically adjustable, above which a gain of the output level is reduced.

3. The audio system of claim 1, wherein a compression factor is manually or automatically adjustable, which determines by how much the output level specified by the volume control is reduced.

4. The audio system of claim 1, wherein the audio compressor is adapted so that its parameterization takes place automatically as a function of a manually adjusted volume.

5. The audio system of claim 1, wherein a data value representing the set volume is transmitted to the base station.

6. The audio system of claim 5, wherein the data value representing the set volume is transmitted to another mobile device.

7. The audio system of claim 6, wherein the other mobile device receives the in-ear monitoring signal.

8. The audio system of claim 5, wherein the base station is enabled by the data value representing the set volume to provide an in-ear monitoring signal with an output level which corresponds to the output level of the in-ear monitoring signal on the mobile device.

9. An audio system comprising a base station connected to a plurality of mobile devices, wherein the base station and the plurality of mobile devices are adapted to exchange data with each other, wherein the base station is connected to an audio mixer which is adapted to receive a plurality of input signals from the plurality of mobile devices, mix them into an overall signal, provide them as an in-ear monitoring signal, and transmit them to a mobile device, which comprises an output amplifier and sound transducers connected thereto,
wherein the mobile device receiving the in-ear monitoring signal has a volume control that allows a playback volume of the in-ear monitoring signal to be adjusted, and
wherein a data value representing a set volume is transmitted to the base station.

10. The audio system of claim 9, wherein the base station comprises an audio compressor which compresses an input signal level of the in-ear monitoring signal as a function of the set volume so that an output level of the output amplifier does not exceed a predetermined limit level.

11. The audio system of claim 9, wherein the data value representing the set volume is transmitted to another mobile device.

12. The audio system according to claim 11, wherein the other mobile device receives the in-ear monitoring signal.

13. The audio system of claim 9, wherein the base station is enabled by the data value representing the set volume to provide an in-ear monitoring signal with an output level which corresponds to the output level of the in-ear monitoring signal on the mobile device.

14. The audio system of claim 9, wherein the audio system is a multi-channel audio system with an antenna, wherein the base station provides an RF channel on which the base station and the mobile devices transmit and receive data in a multiplexing process.

15. A mobile device for an audio system, wherein the mobile device is adapted to output an in-ear monitoring signal and has a volume control for adjusting a set volume of the in-ear monitoring signal, wherein the mobile device has an audio compressor which compresses an input signal level of the in-ear monitoring signal as a function of the set volume such that an output level of an output amplifier does not exceed a predetermined limit level.

16. The mobile device of claim 15, wherein a threshold value of the audio compressor is manually or automatically adjustable, above which a gain of the output level is reduced.

17. The mobile device of claim 15, wherein a compression factor is manually or automatically adjustable, which determines by how much the output level specified by the volume control is reduced.

18. The mobile device of claim 15, wherein the audio compressor is adapted so that its parameterization takes place automatically as a function of a manually adjusted volume.
